(19) United States
(12) Patent Application Publication
(10) Pub. No.: US 2026/0202282 A1
(43) Pub. Date: Jul. 16, 2026

(54) DETERMINING TIRE STATE BASED ON TELEMATICS DATA

(71) Applicant: Quanata, LLC, San Francisco, CA (US)

(72) Inventor: Gil Tamari, San Francisco, CA (US)

(73) Assignee: Quanata, LLC, San Francisco, CA (US)

(21) Appl. No.: 19/022,375

(22) Filed: Jan. 15, 2025

(51) Int. Cl. G01M 17/02; B60C 11/24; B60C 23/04; G06T 7/00

(52) U.S. Cl. CPC G01M 17/02; B60C 11/246; B60C 23/0405; G06T 7/0002; G06T 2207/20048; G06T 2207/20081

(57) ABSTRACT

A method can include receiving a state of a tire of a vehicle, and collecting telematics data for an operator of the vehicle. The method can further include determining an expected state of the tire, and transmitting, for display on a user device, a message regarding the expected state of the tire. The method can also include repeating the collecting, the determining, and the transmitting. The method can further include receiving a current state of the tire. The method can additionally include determining whether the current state of the tire is within a predetermined threshold of the expected state of the tire. The method can also include, when the current state of the tire is determined to not be within the predetermined threshold of the expected state of the tire, resetting the expected state of the tire to be the current state of the tire. Other embodiments are disclosed.

### FIELD OF THE DISCLOSURE

The present disclosure generally relates to determining tire state based on telematics data.

### BACKGROUND

The prediction of tire state is important for vehicle safety and performance. Excessively worn tires can significantly reduce traction to the road, increase braking distances, and heighten the risk of tire blowouts, especially on wet surfaces. The lifespan of a tire predicted by a tire manufacturer is not a one-size-fits-all prediction because the usage of the tire can vary wildly depending on the driving behavior of an operator of a vehicle on which the tires are installed, and also depending on road conditions, weather, etc. Therefore, systems and methods for determining tire state based on the operator's telematics data is desired.

### BRIEF DESCRIPTION OF THE DRAWINGS

The figures described below depict various aspects of the systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates a front elevation view of a computer system that is suitable for implementing an exemplary embodiment of the system disclosed in FIG. 3;

FIG. 2 illustrates a representative block diagram of an example of the elements included in the circuit boards inside a chassis of the computer system of FIG. 1;

FIG. 3 illustrates a system for determining tire state based on telematics data; and

FIG. 4 illustrates a flow chart for determining tire state based on telematics data, according to one exemplary embodiment.

The figures depict preferred embodiments for purposes of illustration only. One skilled in the art will readily recognize from the following discussion that other embodiments of the systems and methods illustrated herein can be employed without departing from the principles of the embodiments described herein.

### DETAILED DESCRIPTION OF THE DRAWINGS

The present embodiments can generally relate to, inter alia, determining a tire stated based on telematics data. The system is capable of prompting an operator to adjust a pressure of the tire. The system can also determine the state of the tire using a machine learning model.

The embodiments described in this patent application can solve one or more of the following technical problems related to tire monitoring and maintenance by using one or more of the following technical solutions. (1) Inaccurate tire state predictions: The system can use a tire wear function that takes into account multiple factors to more accurately determine the expected state of a tire over time. This function can improve upon simpler models that may not account for variables like driver behavior, vehicle specifications, and road conditions. (2) Lack of real-time tire monitoring: By continuously or at least periodically collecting telematics data and updating the expected tire state, the system can provide ongoing monitoring between physical tire inspections. This monitoring can allow potential issues to be identified earlier. (3) Difficulty in detecting anomalous tire wear: The system can compare the current measured tire state to the expected state and can detect when they diverge beyond a threshold. This comparison can enable identification of unusual or premature tire wear that may not be caught by scheduled maintenance alone. (4) Inefficient tire maintenance: By providing targeted messages to the operator about the tire state and prompting actions like pressure adjustments, the system can enable more proactive and timely tire maintenance. (5) Suboptimal tire selection: The system can provide personalized tire recommendations based on the collected telematics data about the operator's driving patterns and conditions. This recommendation can help ensure tires are better matched to actual usage. (6) Challenges in tire state assessment: The system can leverage machine learning models to determine tire state from images, potentially enabling more frequent or convenient tire inspections without specialized equipment. (7) Lack of driver awareness: By providing ongoing updates about tire state to the operator, the system can increase driver awareness of tire condition and maintenance needs. In some embodiments, the embodiments can address these problems through an integrated approach that combines continuous data collection, predictive modeling, anomaly detection, and targeted user notifications. This approach can result in improved tire longevity, safety, and overall vehicle performance in various driving conditions.

More specifically, various embodiments can include a computer-implemented method. The method can include receiving a state of a tire of a vehicle. The method can also include collecting telematics data for an operator of the vehicle. The method can further include determining an expected state of the tire based in part on a tire wear function having factors comprising: at least one of the state of the tire or the expected state of the tire, as previously determined, a specification of the tire, a specification of the vehicle, the telematics data for the operator of the vehicle, and a road condition on which the vehicle has travelled. The method also can further include transmitting, for display on a user device, a message regarding the expected state of the tire. The method can also include repeating the collecting, the determining, and the transmitting. The method can further include receiving a current state of the tire. The method can additionally include determining whether the current state of the tire is within a predetermined threshold of the expected state of the tire, as previously determined. The method can also include when the current state of the tire is determined to not be within the predetermined threshold of the expected state of the tire, as previously determined: resetting the expected state of the tire, as previously determined, to be the current state of the tire, and repeating the collecting, the determining, and the transmitting. The method also can be configured to include additional, less, or other functionality, including that discussed elsewhere herein.

In other embodiments, a system can be provided. The system can include one or more local or remote processors, servers, sensors, memory units, transceivers, mobile devices, wearables, smart watches, smart rings, smart glasses or contacts, augmented reality glasses, virtual reality headsets, mixed or extended reality headsets, voice bots, chat bots, artificial intelligence bots, and/or other electronic or electrical components, which can be in wired or wireless communication with one another. For instance, in one aspect, a computer system can include one or more local or remote processors and/or associated transceivers, along with one or more local or remote non-transitory computer-readable media storing computing instructions that, when run on the one or more processors, cause the one or more processors to perform one or more operations.

The operations can include receiving a state of a tire of a vehicle. The operations can also include collecting telematics data for an operator of the vehicle. The operations can further include determining an expected state of the tire based in part on a tire wear function having factors comprising: at least one of the state of the tire or the expected state of the tire, as previously determined, a specification of the tire, a specification of the vehicle, the telematics data for the operator of the vehicle, and a road condition on which the vehicle has travelled. The operations also can further include transmitting, for display on a user device, a message regarding the expected state of the tire. The operations can also include repeating the collecting, the determining, and the transmitting. The operations can further include receiving a current state of the tire. The operations can additionally include determining whether the current state of the tire is within a predetermined threshold of the expected state of the tire, as previously determined. The operations can also include when the current state of the tire is determined to not be within the predetermined threshold of the expected state of the tire, as previously determined: resetting the expected state of the tire, as previously determined, to be the current state of the tire, and repeating the collecting, the determining, and the transmitting. The system can be configured to include additional, less, or other functionality, including that discussed elsewhere herein.

In further embodiments, a non-transitory computer readable storage medium storing computing instructions can be provided. The computing instructions, when run on one or more processors, can cause the one or more processors to perform operations including receiving a state of a tire of a vehicle. The operations can also include collecting telematics data for an operator of the vehicle. The operations can further include determining an expected state of the tire based in part on a tire wear function having factors comprising: at least one of the state of the tire or the expected state of the tire, as previously determined, a specification of the tire, a specification of the vehicle, the telematics data for the operator of the vehicle, and a road condition on which the vehicle has travelled. The operations also can further include transmitting, for display on a user device, a message regarding the expected state of the tire. The operations can also include repeating the collecting, the determining, and the transmitting. The operations can further include receiving a current state of the tire. The operations can additionally include determining whether the current state of the tire is within a predetermined threshold of the expected state of the tire, as previously determined. The operations can also include when the current state of the tire is determined to not be within the predetermined threshold of the expected state of the tire, as previously determined: resetting the expected state of the tire, as previously determined, to be the current state of the tire, and repeating the collecting, the determining, and the transmitting. The non-transitory computer readable storage medium can be configured to include additional, less, or other functionality, including that discussed elsewhere herein.

Advantages will become more apparent to those skilled in the art from the following description of the preferred embodiments which have been shown and described by way of illustration. As will be realized, the present embodiments can be capable of other and different embodiments, and their details are capable of modification in various respects. Accordingly, the drawings and description are to be regarded as illustrative in nature and not as restrictive.

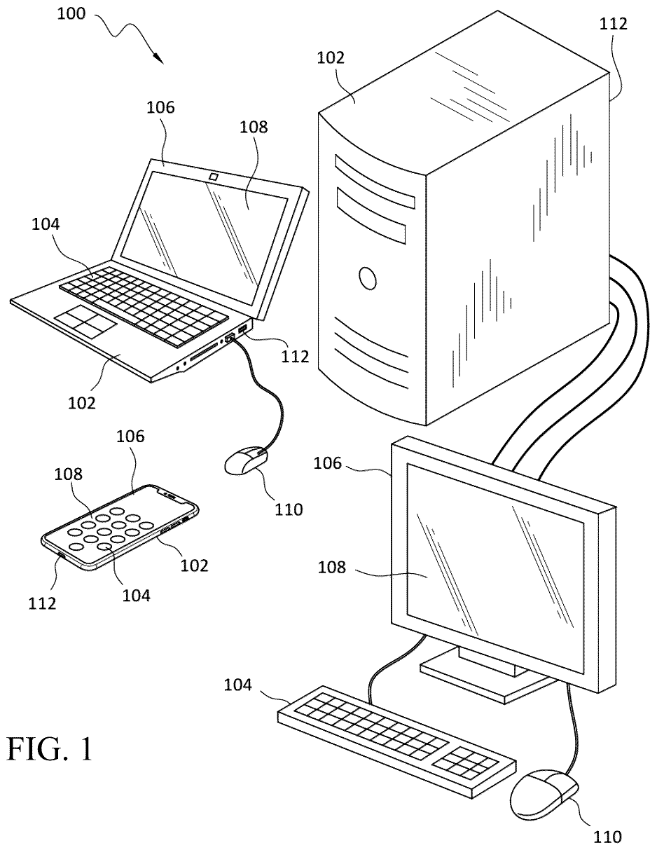

Turning to the drawings, FIG. 1 illustrates an embodiment of three different types (e.g., a laptop, a tower server, and a mobile device) a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part, or all of, the techniques described herein. Computer system 100 can comprise chassis 102 containing one or more circuit boards (not shown) and one or more of an input/output port 112 (e.g., one or more universal serial bus (USB) ports of one or more types (e.g., USB type-A, type-B, type-C, micro-A, micro-B, mini-A, mini-B, etc.), one or more High-Definition Multimedia Interface (HDMI) ports, etc.).

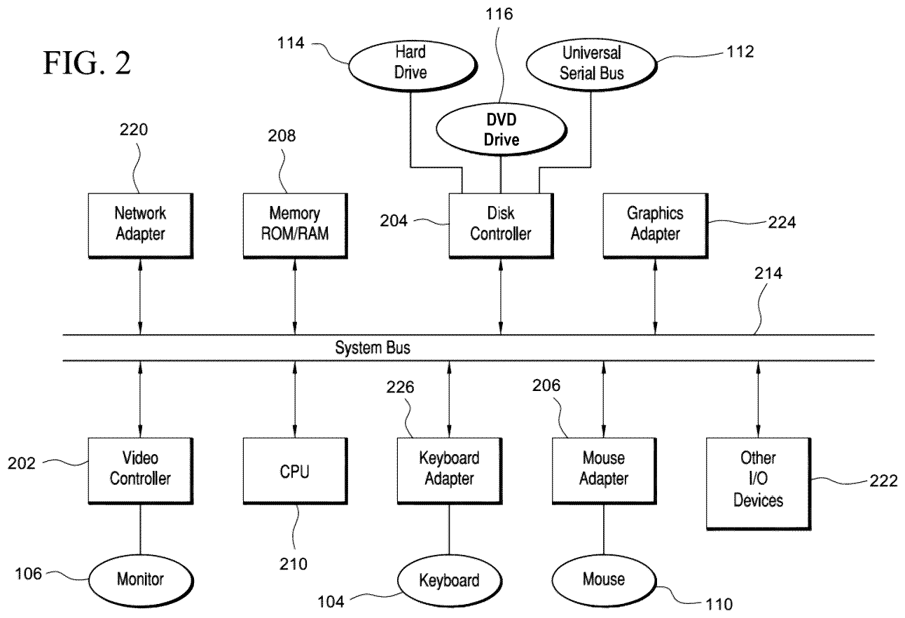

A representative block diagram of the elements included on the circuit boards inside chassis 102 is shown in FIG. 2. A central processing unit (CPU) 210 in FIG. 2 is coupled to a system bus 214. In various embodiments, the architecture of CPU 210 can be compliant with any of a variety of commercially distributed architecture families.

Continuing with FIG. 2, system bus 214 can also be coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to input/output port 112 (FIGS. 1-2)), hard drive 114 (FIG. 2), and/or one or more CD-ROM, DVD, Blu-Ray, or other suitable media, such as media configured to be used in CD-ROM and/or DVD drive 116 (FIG. 2) inside chassis 102 (FIG. 1) or in a detachable drive coupled to input/output port 112 (FIGS. 1-2).

Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS.

Further operating systems can comprise one of the following: (i) the iOS® operating system by Apple Inc. of Cupertino, California, United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, California, United States of America, (v) the Windows Mobile™ operating system by Microsoft Corp. of Redmond, Washington, United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 can be coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIG. 2), input/output port 112 (FIGS. 1-2), and CD-ROM and/or DVD drive 116 (FIG. 2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 by having wireless communication capabilities integrated into the motherboard chipset (not shown), and/or implemented via one or more dedicated wireless communication chips (not shown), connected through a PCI (peripheral component interconnector) or a PCI express bus of computer system 100 (FIG. 1) or input/output port 112 (FIG. 1). In other embodiments, network adapter 220 can comprise and/or be implemented as a wired network interface controller card (not shown).

Although many other components of computer system 100 are not shown, such components and their interconnection are well known to those of ordinary skill in the art. Accordingly, further details concerning the construction and composition of computer system 100 and the circuit boards inside chassis 102 are not discussed herein.

When computer system 100 in FIG. 1 is running, program instructions stored on a USB drive in input/output port 112, on a CD-ROM or DVD in CD-ROM and/or DVD drive 116 (FIG. 2) or in the detachable drive coupled to input/output port 112 (FIGS. 1-2), on hard drive 114 (FIG. 2), or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer.

For purposes of illustration, programs and other executable program components are shown herein as discrete systems, although it is understood that such programs and components can reside at various times in different storage components of computer system 100, and can be executed by CPU 210. In the same or different embodiment, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a laptop computer, a tower server, or a mobile device in FIG. 1, there can be examples where computer system 100 can take a different form factor while still having functional elements similar to those described for computer system 100. In some embodiments, computer system 100 can comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 can comprise a portable computer, such as a laptop computer. In certain other embodiments, computer system 100 can comprise a mobile device, such as a smartphone, smart glasses, smart watch, wearable, virtual reality headset, augmented reality glasses, etc. In certain additional embodiments, computer system 100 can comprise an embedded system.

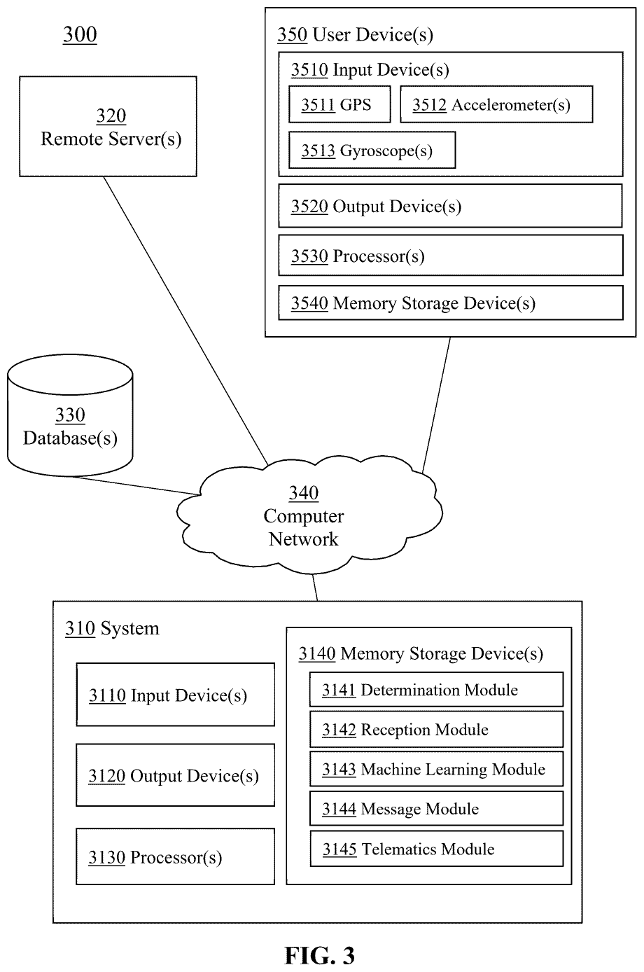

Turning ahead in the drawings, FIG. 3 illustrates a block diagram of a system 300 for revoking access to personal information according to one embodiment. System 300 is an embodiment of the system and is not limited to the embodiments presented herein. The system can be employed in many different embodiments or examples not specifically depicted or described herein. In some embodiments, certain elements, modules, or systems of system 300 can perform various procedures, processes, operations, actions, and/or activities. In other embodiments, the procedures, processes, operations, actions, and/or activities can be performed by other suitable elements, modules, or systems of system 300.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In some embodiments, system 300 can include one or more systems (e.g., a system 310), remote server(s) 320, and/or one or more user devices (e.g., a user device 350). System 310 and user device 350 can each be a computer system, such as computer system 100 (FIG. 1), as described above, and can each be a single computer, a single server, or a cluster or collection of computers or servers, or a cloud of computers or servers. In another embodiment, a single computer system can host each of system 310 and user device 350.

In some embodiments, system 310 can be modules of computing instructions (e.g., software modules) stored on non-transitory computer readable media that operate on one or more processors. In other embodiments, system 310 can be implemented in hardware. In some embodiments, system 310 can comprise one or more systems, subsystems, modules, models, or servers (e.g., a determination module 3141, a transmission module 3142, a machine learning module 3143, a message module 3144, and a telematics module 3145, etc.). Each of determination module 3141, transmission module 3142, machine learning module 3143, message module 3144, and telematics module 3145 can be implemented, at least in part, in software and/or firmware stored in or loaded on memory storage device(s) 3140 and executed on processor(s) 3130. Additional details regarding system 310, remote server(s) 320, and user device(s) 350 are described herein.

In some embodiments, system 310 can be in data communication, through a computer network, a satellite network, a telephone network, or the Internet (e.g., computer network 340), and/or user device 350. In some embodiments, user device 350 can be used by users, such as users for system 310 and/or user device 350.

In certain embodiments, system 310 can host one or more websites and/or mobile application servers. For example, system 310 can host a website, or provide a server that interfaces with an application (e.g., a mobile application or a web browser), on user device 350. In some embodiments, an internal network (e.g., computer network 340) that is not open to the public can be used for communications between system 310, remote server(s) 320, and/or user device 350 within system 300.

In some embodiments, each of user device(s) 350 can include one or more input devices (e.g., input device(s) 3510), one or more output devices (e.g., output device(s) 3520), one or more processors (e.g., processor(s) 3530), and/or one or more memory storage devices (e.g., memory storage device(s) 3540). Examples of input device(s) 3510 can include one or more keyboards, one or more keypads, one or more pointing devices such as a computer mouse or computer mice, one or more touchscreen displays, a microphone, a camera, keyboard 104 (FIG. 1), mouse 110 (FIG. 1), etc. Examples of output device(s) 3520 can include one or more monitors, one or more touch screen displays, projectors, monitor 106 (FIG. 1), screen 108 (FIG. 1), etc. Examples of processor(s) 3530 can include CPU 210 (FIG. 2), etc. Examples of memory storage device(s) 3540 can include memory storage unit 208 (FIG. 2), external storage units coupled to input/output port 112 (FIGS. 1-2), hard drive 114 (FIG. 2), CD-ROM and/or DVD drive 116 (FIG. 2), a detachable drive coupled to input/output port 112 (FIGS. 1-2), etc. In a number of embodiments, input device(s) 3510 further can include one or more cameras and/or one or more microphones. In the same or different embodiments, input device(s) 3510 can include one or more GPS (Global Positioning System) sensor(s) (e.g., GPS sensor(s) 3511), one or more accelerometers (e.g., accelerometer(s) 3512), and/or one or more gyroscopes (e.g., gyroscope(s) 3513). In the same or different embodiments, user device(s) 350 can comprise one or more systems, subsystems, modules, models, or servers.

In some embodiments, user device 350 can include one or more input devices (e.g., input device(s) 3510), one or more output devices (e.g., output device(s) 3520), one or more processors (e.g., processor(s) 3530), and/or one or more memory storage devices (e.g., memory storage device(s) 3540). Examples of input device(s) 3510 can include one or more keyboards, one or more keypads, one or more pointing devices such as a computer mouse or computer mice, one or more touchscreen displays, a microphone, keyboard 104 (FIG. 1), mouse 110 (FIG. 1), etc. Examples of output device(s) 3520 can include one or more monitors, one or more touch screen displays, projectors, monitor 106 (FIG. 1), screen 108 (FIG. 1), etc. Examples of processor(s) 3530 can include CPU 210 (FIG. 2), etc. Examples of memory storage device(s) 3540 can include memory storage unit 208 (FIG. 2), external storage units coupled to input/output port 112 (FIGS. 1-2), hard drive 114 (FIG. 2), CD-ROM and/or DVD drive 116 (FIG. 2), a detachable drive coupled to input/output port 112 (FIGS. 1-2), etc.

Input device(s) 3510 and output device(s) 3520 can be coupled to user device 350 in a wired manner and/or a wireless manner, and the coupling can be direct and/or indirect, as well as locally and/or remotely. As an example of an indirect manner (which can or cannot also be a remote manner), a keyboard-video-mouse (KVM) switch can be used to couple input device(s) 3510 and output device(s) 3520 to processor(s) 3530 and/or memory storage device(s) 3540. In some embodiments, the KVM switch also can be part of user device 350. In a similar manner, processor(s) 3530 and/or memory storage device(s) 3540 can be local and/or remote to each other.

In certain embodiments, the user devices (e.g., user device 350) can be a mobile device, and/or other endpoint devices used by one or more users. A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device (e.g., smart glasses, smart watches, an augmented-reality (AR) headset, a virtual-reality (VR) headset, etc.), or another portable computer device with the capability to present audio and/or visual data (e.g., images, videos, music, etc.).

Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Mobile devices can include (i) an iPod®, iPhone®, iTouch®, iPad®, MacBook® or similar product by Apple Inc. of Cupertino, California, United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, California, United States of America, (ii) the Blackberry® operating system by Research In Motion (RIM) of Waterloo, Ontario, Canada, (iii) the Android™ operating system developed by the Open Handset Alliance, or (iv) the Windows Mobile™ operating system by Microsoft Corp. of Redmond, Washington, United States of America.

In some embodiments, system 310 can include: (a) one or more input devices (e.g., input device(s) 3110 such as one or more keyboards, one or more keypads, one or more pointing devices such as a computer mouse or computer mice, one or more touchscreen displays, a microphone, etc.), (b) one or more display devices (e.g., output device(s) 3120 such as one or more monitors, one or more touch screen displays, projectors, etc.), (c) one or more processors (e.g., processor(s) 3130), and/or (d) one or more memory storage devices (e.g., memory storage device(s) 3540 such as one or more internal or external memory storage units, one or more hard drives, one or more CD-ROM or DVD drives, etc.). In these or other embodiments, one or more of the input device(s) (e.g., input device(s) 3110) can be similar or identical to keyboard 104 (FIG. 1) and/or a mouse 110 (FIG. 1). Further, one or more of the display device(s) (e.g., output device(s) 3120) can be similar or identical to monitor 106 (FIG. 1) and/or screen 108 (FIG. 1). Additionally, one or more of the processors (e.g., processor(s) 3130) can be similar or identical to CPU 210 (FIG. 2). In similar or different embodiments, one or more of the memory storage devices (e.g., memory storage device(s) 3140) can be similar or identical to memory storage unit 208 (FIG. 2), external storage units coupled to input/output port 112 (FIGS. 1-2), hard drive 114 (FIG. 2), CD-ROM and/or DVD drive 116 (FIG. 2), or a detachable drive coupled to input/output port 112 (FIGS. 1-2).

The input device(s) (e.g., input device(s) 3110) and the display device(s) (e.g., output device(s) 3120) can be coupled to system 310 in a wired manner and/or a wireless manner, and the coupling can be direct and/or indirect, as well as locally and/or remotely. As an example of an indirect manner (which can or cannot also be a remote manner), a keyboard-video-mouse (KVM) switch can be used to couple the input device(s) (e.g., input device(s) 3110) and the display device(s) (e.g., output device(s) 3120) to the processor(s) (e.g., processor(s) 3130) and/or the memory storage unit(s) (e.g., memory storage device(s) 3140). In some embodiments, the KVM switch also can be part of system 310. In a similar manner, the processors and/or the non-transitory computer-readable media can be local and/or remote to each other.

Meanwhile, in some embodiments, system 310 also can be configured to communicate with one or more databases (e.g., a database(s) 330). The one or more databases can include features of template tires, specifications of the tire (type of vehicle the tire is for, width of the tire, aspect ratio of the tire, construction of the tire, rim diameter of the tire, load index of the tire, and speed rating of the tire), specifications of the vehicle (curb weight, spring rate of a suspension of the vehicle, maximum power output rating (at a crankshaft and/or wheel of the vehicle), torque rating, 4-wheel drive (activation of 4-wheel drive can be detected by speed of the vehicle and the terrain that the vehicle is driving on) etc.), weather during a trip taken by the operator, whether the vehicle is towing, telematics data for the operator of the vehicle, and/or a road condition on which the vehicle has traveled.

The one or more databases additionally can include one or more of trained machine learning (ML) and/or artificial intelligence (AI) models (the ML/AI models) used in system 300 and/or system 310. The one or more databases further can include training datasets for various ML/AI models, modules, or systems, etc. The training datasets can be obtained from a third party, generated manually, and/or curated from historical input/output data of one or more pre-trained ML/AI models, etc.

The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, system 300, system 310, and/or the one or more databases (e.g., database(s) 330) can be implemented using any suitable manner of wired and/or wireless communication. Accordingly, system 300 and/or system 310 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). PAN protocol(s) can include Bluetooth, Zigbee, Wireless Universal Serial Bus (USB), Z-Wave, etc.; LAN and/or WAN protocol(s) can include Institute of Electrical and Electronic Engineers (IEEE) 802.3 (also known as Ethernet), IEEE 802.11 (also known as WiFi), etc.; and wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc.

The specific communication software and/or hardware implemented can depend on the network topologies and/or protocols implemented, and vice versa. In some embodiments, communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further communication hardware can include wireless communication hardware including, for example, one or more radio transceivers, one or more infrared transceivers, etc. Additional communication hardware can include one or more networking components (e.g., modulator-demodulator components, gateway components, etc.).

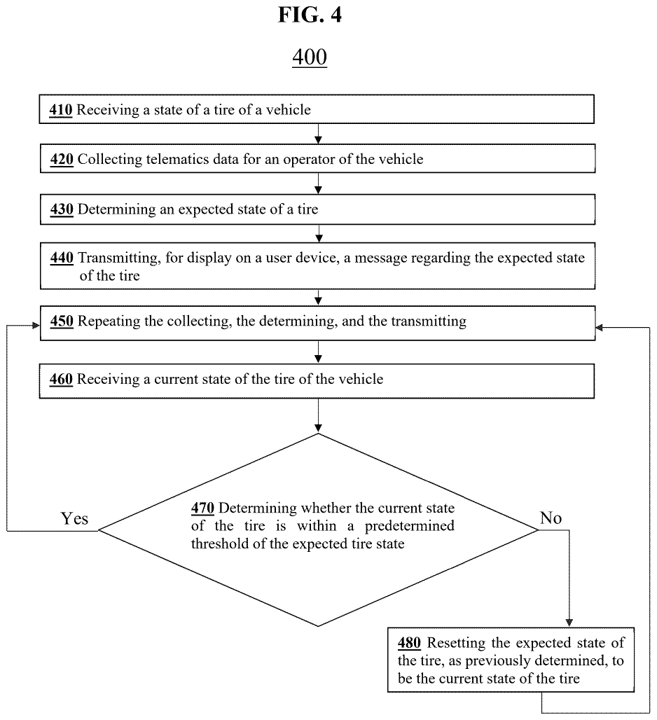

Turning ahead in the drawings, FIG. 4 illustrates actions of a method 400 for determining a tire state. Method 400 can be implemented via execution of computing instructions configured to run on one or more processors and stored on one or more non-transitory computer-readable media. Method 400 is an embodiment and is not limited to the embodiments presented herein. Method 400 can be employed in many different embodiments or examples not specifically depicted or described herein.

In some embodiments, the procedures, the processes, the operations, the actions, and/or the activities of method 400 can be performed in the order presented. In other embodiments, the procedures, the processes, the operations, the actions, and/or the activities of method 400 can be performed in any suitable order. In still other embodiments, one or more of the procedures, the processes, the operations, the actions, and/or the activities of method 400 can be combined or skipped.

In some embodiments, system 300 or system 310 (FIG. 3) (including one or more of its elements, modules, and/or systems, such as determination module 3141, transmission module 3142, machine learning module 3143, message module 3144, telematics module 3145, etc.) can be suitable to perform method 400 and/or one or more of the operations, actions, and/or activities of method 400. In these or other embodiments, one or more of the operations, actions, and/or activities of method 400 can be implemented as one or more computing instructions configured to run on one or more processors and configured to be stored on one or more non-transitory computer readable media. Such non-transitory computer readable media can be part of a computer system such as system 300 or system 310. The processor(s) can be similar or identical to the processor(s) described above with respect to computer system 100 (FIG. 1).

Referring to FIG. 4, in some embodiments, method 400 can include a block 410 of receiving a state of a tire of a vehicle. The state of the tire of the vehicle can be determined manually when the vehicle is being inspected (e.g. routine car maintenance). Physical measurements of the tire can be taken including tread depth, the pressure of the tire. A tread wear pattern of the tire can also be recorded. The physical measurements can be taken using a manual process with a manual measurement device or using an automated process with a camera, lasers, and a computer vision system.

In some embodiments, the state of the tire can be determined using machine learning. A machine learning model can determine the state of the tire (e.g. pressure of the tire, tread depth of the tire, and tread wear pattern of the tire) by processing one or more images of the tire. The machine learning model can be trained to identify features from the one or more images of the tire. The trained machine learning model can then be used to identify features from the one or more images of the tire.

More specifically, the machine learning model may identify features from the one or more images of the tire, such as the geometry of the edges of the tire, and red, green, blue (RGB) pixel values or colors within the tire. These features may be identified by detecting stable regions within the tire that are detectable regardless of blur, motion, distortion, orientation, illumination, scaling, and/or other changes in camera perspective. The stable regions may be extracted from the tire using a scale-invariant feature transform (SIFT), speeded up robust features (SURF), fast retina keypoint (FREAK), binary robust invariant scalable keypoints (BRISK), or any other suitable computer vision techniques. In some embodiments, keypoints may be located at high-contrast regions of the tire, such as edges within the tire. A bounding box may be formed around a keypoint and the portion of the tire created by the bounding box may be a feature.

In some embodiments, the features of the tire can be compared to the features of tires in various states (e.g. 10% wear, 20% wear, 30% wear... 80% wear, 85% wear, 99% wear, and 100% wear) using image classification and/or machine learning techniques. The machine learning techniques may include linear regression, polynomial regression, logistic regression, random forests, boosting, nearest neighbors, Bayesian networks, neural networks, support vector machines, or any other suitable machine learning technique. For example, the widths and heights of tires in various states may be stored as template features along with ratios of the diameter of the wheels compared to the thickness of the tires, shapes of the tires, thickness metrics at various positions within the tire, tire pressures, and tread wear patterns, etc. The template tire may include representations of tires in good states (e.g. 10% wear, 20% wear, and 30% wear) with various amounts of tire pressure and tire material as well as representations of tires in moderate or poor states (e.g. 40% wear, 50% wear, 80% wear, 85% wear, 99% wear, and 100% wear) such as flat tires, tires with low tire pressure, tires having thinning tire material, etc. In some embodiments, the template features may be compared to the features for the tire using a nearest neighbors algorithm. The nearest neighbors algorithm may identify template features which are the closest to the features of the tire by creating numerical representations of the features to generate feature vectors, such as a pixel width and height of a tire in the one or more images, and RGB pixel values for the tire in the one or more images, for example. The numerical representations of the features or feature vectors of the tire may be compared to the feature vectors of the template tire to determine a vector distance between the features of the tire and each template tire. The state of the tire may then be determined based at least in part upon the amount of similarity, or the vector distance in the nearest neighbors algorithm, between the features for the tire and the features for the template tire that represent tires in various states and/or having various amounts of wear and tear. For example, if the closest template tire represents a tire at 20% wear, the tire is identified as a tire at 20% wear.

In some embodiments, the template features may be compared to the features of the tire using a nearest neighbors algorithm. The nearest neighbors algorithm may identify template features which are the closest to the features of the tire by creating numerical representations of the features to generate feature vectors, such as a pixel width and height of a tire, and RGB pixel values for the tire, for example. The numerical representations of the features or feature vectors of the tire may be compared to the feature vectors of template tire to determine a vector distance between the features of the tire and each template tire. The state of the tire can be determined based at least in part upon the amount of similarity, or the vector distance in the nearest neighbors algorithm, between the features of the tire and the features for template tire that represent tires in various conditions and/or having various amounts of wear and tear. For example, if the closest template tire represents a tire at 20% wear, the tire is identified as a tire at 20% wear.

In some embodiments, method 400 further can include a block 420 of collecting telematics data for an operator of the vehicle. In some embodiments, the telematics data can be collected by a mobile electronic device (e.g., one of user device(s) 350 (FIG. 3)) of an operator who is driving a vehicle. In these embodiments, the operator can authorize an app on the mobile electronic device to use sensors (e.g., GPS sensors 3511, accelerometer(s) 3512, and gyroscope(s) 3513 on the mobile electronic device to collect the telematics data during a vehicle trip. The operator can authorize the app to use the sensors to collect the telematics data before the vehicle trips begins or at the beginning of the vehicle trip. In other embodiments, the app automatically uses the sensors to collect the telematics data during the vehicle trip, and does not require the operator to authorize the app to do so. In still other embodiments, the telematics data can be transmitted by the vehicle being driven by the user. Regardless of the source of the telematics data, the telematics data can be received directly from the source or indirectly from the source through the Internet and/or a cellular network. The telematics data can include GPS data such as speed, acceleration, deceleration, elevation, incline, decline, turning, bumps, etc. Telematics data can also include whether the operator is towing with the vehicle. Towing can be detected by the operator indicating that he is towing with the vehicle and can specify the load being towed. The operator can also indicate that he is no longer towing.

In a number of embodiments, method 400 also can include a block 430 of determining an expected state of a tire. The expected state of the tire can be determined through a machine learning model (e.g. linear classification or regression) and expressed as a value or as a percentage. The machine learning model can model the state of the tire as a function of various factors including the current or expected state of the tire, specifications of the tire (type of vehicle the tire is for, width of the tire, aspect ratio of the tire, construction of the tire, rim diameter of the tire, load index of the tire, and speed rating of the tire), specifications of the vehicle (curb weight, spring rate of a suspension of the vehicle, maximum power output rating (at a crankshaft and/or wheel of the vehicle), torque rating, etc.), weather during a trip taken by the operator, telematics data for the operator of the vehicle, and/or a road condition on which the vehicle has traveled.

Road condition of the vehicle can include a curve rating of the road, an incline/decline rating, which can be received from publicly available sources. Road condition can also include how bumpy/rough the road is, which can be received from the telematics data of the operator.

In some embodiments, method 400 further can include a block 440 of transmitting, for display on a user device, a message regarding the expected state of the tire. The message may inform the user or operator of the state of the tire. For example, the message may inform the user that the tire is at 50% wear, inform that user that the tire is at 90% wear and to replace the tire soon, inform the user that there is premature wear of the tire, and/or prompt the user to adjust the pressure of the tire.

In some embodiments, method 400 further can include a block 450 of repeating the collecting, the determining, and the transmitting (blocks 420, 430, and 440). Block 450 also can be performed after performing block 470, when a current state of the tire is within a threshold of the expected tire state or after performing block 480, after resetting the expected state of the tire, as previously determined, to be the current state of the tire.

In some embodiments, method 400 further can include a block 460 of receiving a current state of the tire of the vehicle. In some embodiments, blocks 410 and 460 can be similar to each other, except that they measure a state of the tire of the vehicle at different points in time. The current state of the tire of the vehicle can be determined manually when the vehicle is being inspected. Physical measurements of the tire can be taken including tread depth, the pressure of the tire. A tread wear pattern of the tire can also be recorded. The physical measurements can be taken using a manual process with a manual measurement device or using an automated process with a camera, lasers, and a computer vision system.

In some embodiments, the current state of the tire can be determined automatically and using machine learning. A machine learning model can determine the current state of the tire (e.g. pressure of the tire, tread depth of the tire, and tread wear pattern of the tire) by processing one or more images of the tire. The machine learning model can be trained to identify features from the one or more images of the tire. The trained machine learning model can then be used to identify features from the one or more images of the tire.

More specifically, the machine learning model may identify features from the one or more images of the tire, such as the geometry of the edges of the tire, and RGB pixel values or colors within the tire. These features may be identified by detecting stable regions within the tire that are detectable regardless of blur, motion, distortion, orientation, illumination, scaling, and/or other changes in camera perspective. The stable regions may be extracted from the tire using a scale-invariant feature transform (SIFT), speeded up robust features (SURF), fast retina keypoint (FREAK), binary robust invariant scalable keypoints (BRISK), or any other suitable computer vision techniques. In some embodiments, keypoints may be located at high-contrast regions of the tire, such as edges within the tire. A bounding box may be formed around a keypoint and the portion of the tire created by the bounding box may be a feature.

In some embodiments, the features of the tire can be compared to the features of tires in various states (e.g. 10% wear, 20% wear, 30% wear . . . 80% wear, 85% wear, 99% wear, and 100% wear) using image classification and/or machine learning techniques. The machine learning techniques may include linear regression, polynomial regression, logistic regression, random forests, boosting, nearest neighbors, Bayesian networks, neural networks, support vector machines, or any other suitable machine learning technique. For example, the widths and heights of tires in various states may be stored as template features along with ratios of the diameter of the wheels compared to the thickness of the tires, shapes of the tires, thickness metrics at various positions within the tire, tire pressures, and tread wear patterns, etc. The template tire may include representations of tires in good states (e.g. 10% wear, 20% wear, and 30% wear) with various amounts of tire pressure and tire material as well as representations of tires in moderate or poor states (e.g. 40% wear, 50% wear, 80% wear, 85% wear, 99% wear, and 100% wear) such as flat tires, tires with low tire pressure, tires having thinning tire material, etc. In some embodiments, the template features may be compared to the features for the tire using a nearest neighbors algorithm. The nearest neighbors algorithm may identify template features which are the closest to the features of the tire by creating numerical representations of the features to generate feature vectors, such as a pixel width and height of a tire in the one or more images, and RGB pixel values for the tire in the one or more images, for example. The numerical representations of the features or feature vectors of the tire may be compared to the feature vectors of the template tire to determine a vector distance between the features of the tire and each template tire. The current state of the tire may then be determined based at least in part upon the amount of similarity, or the vector distance in the nearest neighbors algorithm, between the features for the tire and the features for the template tire that represent tires in various states and/or having various amounts of wear and tear. For example, if the closest template tire represents a tire at 20% wear, the tire is identified as a tire at 20% wear.

In some embodiments, the template features may be compared to the features of the tire using a nearest neighbors algorithm. The nearest neighbors algorithm may identify template features which are the closest to the features of the tire by creating numerical representations of the features to generate feature vectors, such as a pixel width and height of a tire, and RGB pixel values for the tire, for example. The numerical representations of the features or feature vectors of the tire may be compared to the feature vectors of template tire to determine a vector distance between the features of the tire and each template tire. The current state of the tire can be determined based at least in part upon the amount of similarity, or the vector distance in the nearest neighbors algorithm, between the features of the tire and the features for template tire that represent tires in various conditions and/or having various amounts of wear and tear. For example, if the closest template tire represents a tire at 20% wear, the tire is identified as a tire at 20% wear.

In some embodiments, method 400 further can include a block 470 of determining whether the current state of the tire is within a predetermined threshold of the expected tire state. The predetermined threshold can be set as a numerical range within the expected state of the tire or as a percentage within the expected state of the tire. The predetermined threshold can be different depending on the expected state of the tire. For example, a tire with 10% wear can have a bigger threshold of 15% within the expected state of the tire, while a tire with 90% wear can have a smaller threshold of within 1% of the expected state of the tire.

In some embodiments, if the current state of the tire is within the predetermined threshold of the expected tire state, then the collecting, determining, and transmitting steps are repeated (block 450). If the current state of the tire is not within the predetermined threshold of the expected tire state, then block 480 is performed.

In some embodiments, method 400 further can include a block 480 of resetting the expected state of the tire, as previously determined, to be the current state of the tire. For example, if the current tire state is a first value and the expected tire state is a second value, the value of the expected tire state can be adjusted to the first value. After performing block 480, block 450 of repeating the collecting, the determining, and the transmitting (block 450) can be performed.

In some embodiments, method 400 can further include providing a recommendation for a new tire to the operator based in part on the telematics data for the operator of the vehicle. For example, if the telematics data indicates that the operator spends most of his time driving in snow, then winter tires can be recommended to the operator. In the telematics data indicates that the operator spends most of his time driving in geographic regions that does not snow, then summer tires can be recommended. If the operator drives in a geographic region with a lot of rain, then tires with more contact that also reduce hydroplaning can be recommended. If the telematics data indicates that the operator often takes the vehicle off-roading, then off-roading tires can be recommended. If the telematics data indicates that the operator is an aggressive driver, more durable tires can be recommended.

Relating FIG. 4 to FIG. 3, as an example, determination module 3141 (FIG. 3) and other parts of system 310 can perform all or a portion of blocks 430, 470, and 480; reception module 3142 (FIG. 3) and other parts of system 310 can perform all or a portion of blocks 410 and 460; machine learning module 3143 (FIG. 3) and other parts of system 310 can determine the state of the tire or the current state of the tire using a machine learning model (e.g. blocks, 410, 430, 460); message module 3144 (FIG. 3) and other parts of system 310 can perform block 440; and telematics module 3145 (FIG. 3) and other parts of system 310 can perform block 420.

In many embodiments, the systems and/or methods can use one or more ML/AI models to perform one or more of the above-mentioned procedures, processes, activities, actions, operations, and/or methods. Further, the systems and/or methods can use one or more natural language processing (NLP) models for processing the one or more inputs and/or outputs (e.g., interpreting user feedback). Examples of the algorithms used for the various ML/AI models can include BERT, LLM, Lambda, Palm, XLNet, GPT-3, GPT-4, KNN, decision trees, linear regression, K-Means, neural networks, fuzzy logic, GANs, CTGAN, CNNs, VAEs, and so forth. In various embodiments, each of the ML/AI models used can be trained dynamically and/or regularly.

In many embodiments, the systems and/or methods can be configured to train or re-train the one or more ML/AI models. The training of each of the ML/AI models can be supervised, semi-supervised, and/or unsupervised, which in some embodiments can be followed by, or used in conjunction with, other techniques, such as re-enforcement machine learning techniques, or other techniques utilized by ChatGPT-based voice bots or virtual assistants. The training data of training datasets for pre-training or re-training each of the ML/AI models can be collected from various data sources, including historical input and/or output data by the ML/AI model. The collection and update of the training data in the training datasets can be performed once, periodically (e.g., every day, every week, etc.), or constantly. For example, in certain embodiments, the input and/or output data of an ML/AI model can be curated by a user (e.g., an ML engineer, a data scientist, etc.) or automatically collected every time the ML/AI model generates new output data to update the training datasets for re-training the ML/AI model. In many embodiments, the trained and/or re-trained ML/AI model as well as the training datasets can be stored in, updated, and accessed from a database (e.g., database(s) 330 (FIG. 3)).

In some embodiments, the systems, methods, and/or system users (e.g., a data scientist) further can determine whether to add the newly-created historical input and/or output data to the training dataset for retraining the ML/AI models based upon user feedback, predetermined criteria, and/or confidence scores for the historical output data. The user feedback can be associated with the output data of the ML/AI models or the output of the systems and/or methods using the ML/AI models.

In certain embodiments where machine learning techniques are not explicitly described in the processes, procedures, activities, operations, actions, and/or methods, such processes, procedures, activities, operations, actions, and/or methods can be read to include machine learning techniques suitable to perform the intended activities (e.g., determining, processing, analyzing, predicting, etc.). In several embodiments, the one or more ML/AI models can be configured to start or stop automatically upon occurrence of predefined events and/or conditions. In certain embodiments, the systems and/or methods can use a pre-trained ML/AI model, without any re-training.

Although a system, method, and non-transitory computer readable storage medium storing computer instructions for determining tire state based on telematics has been described with reference to specific embodiments, it will be understood by those skilled in the art that various changes can be made without departing from the spirit or scope of the disclosure. Accordingly, the disclosure of embodiments is intended to be illustrative of the scope of the disclosure and is not intended to be limiting.

It is intended that the scope of the disclosure shall be limited only to the extent required by the appended claims. For example, to one of ordinary skill in the art, it will be readily apparent that any element of FIG. 1-4 can be modified, and that the foregoing discussion of certain of these embodiments does not necessarily represent a complete description of all possible embodiments. Additionally, one or more of the procedures, processes, operations, actions, and/or activities of the method in FIG. 4 can include different procedures, processes, actions, and/or activities and be performed by many different modules, in many different orders. As another example, the modules, models, elements, and/or systems within system 300 or system 310 in FIG. 3 can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that can cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

As will be appreciated based upon the foregoing specification, the above-described embodiments of the disclosure can be implemented using computer programming or engineering techniques including computer software, firmware, hardware or any combination or subset thereof. Any such resulting program, having computer-readable code means, can be embodied, or provided within one or more computer-readable media, thereby making a computer program product, e.g., an article of manufacture, according to the discussed embodiments of the disclosure. The computer-readable media can be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code can be made and/or used by executing the code directly from one medium, by copying the code from one medium to another medium, or by transmitting the code over a network.

These computer programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor can include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

In one embodiment, a computer program is provided, and the program is embodied on a computer readable medium. In an embodiment, the system can be executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various environments without compromising any major functionality. In some embodiments, the system includes multiple components distributed among a plurality of computing devices. One or more components can be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and preceded by the word “a” or “an” should be understood as not excluding plural elements, actions, operations, or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

For simplicity and clarity of illustration, the drawing figures illustrate the general manner of construction, and descriptions and details of well-known features and techniques can be omitted to avoid unnecessarily obscuring the present disclosure. Additionally, elements in the drawing figures are not necessarily drawn to scale. For example, the dimensions of some of the elements in the figures can be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but can include other elements not expressly listed or inherent to such process, method, system, article, device, or apparatus.

The terms “couple,” “coupled,” “couples,” “coupling,” and the like should be broadly understood and refer to connecting two or more elements mechanically and/or otherwise. Two or more electrical elements can be electrically coupled together, but not be mechanically or otherwise coupled together. Coupling can be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, “approximately” may, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

This written description uses examples to disclose the disclosure, including the best mode, and to enable any person skilled in the art to practice the disclosure, including making and using any devices or computer systems and performing any incorporated computer-based or computer-implemented methods. The patentable scope of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer-implemented method comprising:
receiving a state of a tire of a vehicle;
collecting telematics data for an operator of the vehicle;
determining an expected state of the tire based in part on a tire wear function having factors comprising:
at least one of the state of the tire or the expected state of the tire, as previously determined;
a specification of the tire;
a specification of the vehicle;
the telematics data for the operator of the vehicle; and
a road condition on which the vehicle has traveled;
transmitting, for display on a user device, a message regarding the expected state of the tire;
repeating the collecting, the determining, and the transmitting;
receiving a current state of the tire;
determining whether the current state of the tire is within a predetermined threshold of the expected state of the tire, as previously determined; and
when the current state of the tire is determined to not be within the predetermined threshold of the expected state of the tire, as previously determined:
resetting the expected state of the tire, as previously determined, to be the current state of the tire; and
repeating the collecting, the determining, and the transmitting.

2. The computer-implemented method of claim 1, wherein the factors further comprise at least one of:
a weather condition through which the tire was driven; or
an elevation in which the tire was driven.

3. The computer-implemented method of claim 1, wherein the state of the tire or the expected state of the tire, as previously determined, comprises at least one of:
a pressure of the tire;
a tread depth of the tire; or
a tread wear pattern of the tire.

4. The computer-implemented method of claim 1, wherein the message prompts the operator to adjust a pressure of the tire.

5. The computer-implemented method of claim 1, wherein the current state of the tire, as received, is determined using a machine learning model comprising:
generating numerical representations of features identified in one or more images of the tire to generate feature vectors; and
comparing the feature vectors to feature vectors of template tires to determine the state of the tire.

6. The computer-implemented method of claim 5, wherein the features are extracted from the one or more images of the tire by (i) detecting stable regions within the one or more images of the tire using a scale-invariant feature transform, (ii) locating keypoints in the stable regions, and (iii) forming a bounding box around the keypoints representing the features.

7. The computer-implemented method of claim 1, further comprising providing a recommendation for a new tire to the operator based in part on the telematics data for the operator of the vehicle.

8. A system comprising:
one or more processors; and
one or more non-transitory computer-readable media storing computing instructions that, when executed on the one or more processors, cause the one or more processors to perform operations comprising:
receiving a state of a tire of a vehicle;
collecting telematics data for an operator of the vehicle;
determining an expected state of the tire based in part on a tire wear function having factors comprising:
at least one of the state of the tire or the expected state of the tire, as previously determined;
a specification of the tire;
a specification of the vehicle;
the telematics data for the operator of the vehicle; and
a road condition on which the vehicle has traveled;
transmitting, for display on a user device, a message regarding the expected state of the tire;
repeating the collecting, the determining, and the transmitting;
receiving a current state of the tire;
determining whether the current state of the tire is within a predetermined threshold of the expected state of the tire, as previously determined; and
when the current state of the tire is determined to not be within the predetermined threshold of the expected state of the tire, as previously determined:
resetting the expected state of the tire, as previously determined, to be the current state of the tire; and
repeating the collecting, the determining, and the transmitting.

9. The system of claim 8, wherein the factors further comprise at least one of:
a weather condition through which the tire was driven; or
an elevation in which the tire was driven.

10. The system of claim 8, wherein the state of the tire or the expected state of the tire, as previously determined, comprises at least one of:
a pressure of the tire;
a depth of the tire; or
a tread wear pattern of the tire.

11. The system of claim 8, wherein the message prompts the operator to adjust a pressure of the tire.

12. The system of claim 8, wherein the current state of the tire, as received, is determined using a machine learning model comprising:
generating numerical representations of features identified in one or more images of the tire to generate feature vectors; and
comparing the feature vectors to feature vectors of template tires to determine the state of the tire.

13. The system of claim 12, wherein the features are extracted from the one or more images of the tire by (i) detecting stable regions within the one or more images of the tire using a scale-invariant feature transform, (ii) locating keypoints in the stable regions, and (iii) forming a bounding box around the keypoints representing the features.

14. The system of claim 8, wherein the operations further comprise:
providing a recommendation for a new tire to the operator based in part on the telematics data for the operator of the vehicle.

15. A non-transitory computer readable storage medium storing computing instructions that, when run on a processor, cause the processor to perform operations comprising:
receiving a state of a tire of a vehicle;
collecting telematics data for an operator of the vehicle;
determining an expected state of the tire based in part on a tire wear function having factors comprising:
at least one of the state of the tire or the expected state of the tire, as previously determined;
a specification of the tire;
a specification of the vehicle;
the telematics data for the operator of the vehicle; and
a road condition on which the vehicle has traveled;
transmitting, for display on a user device, a message regarding the expected state of the tire;
repeating the collecting, the determining, and the transmitting;
receiving a current state of the tire;
determining whether the current state of the tire is within a predetermined threshold of the expected state of the tire, as previously determined; and
when the current state of the tire is determined to not be within the predetermined threshold of the expected state of the tire, as previously determined:
resetting the expected state of the tire, as previously determined, to be the current state of the tire; and
repeating the collecting, the determining, and the transmitting.

16. The non-transitory computer readable storage medium of claim 15, wherein the factors further comprise at least one of:
a weather condition through which the tire was driven; or
an elevation in which the tire was driven.

17. The non-transitory computer readable storage medium of claim 15, wherein the state of the tire or the expected state of the tire, as previously determined, comprises at least one of:
a pressure of the tire;
a tread depth of the tire; or
a tread wear pattern of the tire.

18. The non-transitory computer readable storage medium of claim 15, wherein the message prompts the operator to adjust a pressure of the tire.

19. The non-transitory computer readable storage medium of claim 15, wherein at least one of:
(a)
the current state of the tire, as received, is determined using a machine learning model comprising:
generating numerical representations of features identified in one or more images of the tire to generate feature vectors; and
comparing the feature vectors to feature vectors of template tires to determine the state of the tire; or
(b)
the features are extracted from the one or more images of the tire by (i) detecting stable regions within the one or more images of the tire using a scale-invariant feature transform, (ii) locating keypoints in the stable regions, and (iii) forming a bounding box around the keypoints representing the features.

20. The non-transitory computer readable storage medium of claim 15, wherein the operations further comprise:
providing a recommendation for a new tire to the operator based in part on the telematics data for the operator of the vehicle.
